(19) United States
(12) Patent Application Publication
(10) Pub. No.: US 2010/0187330 A1
(43) Pub. Date: Jul. 29, 2010

(54) Sprinkler head washer stack

(76) Inventor: Mark Healy, Orlando, FL (US)

Correspondence Address: William M. Hobby, III, 157 E. New England Ave., #375, Winter Park, FL, 32789, US

(21) Appl. No.: 12/662,049

(22) Filed: Mar. 29, 2010

Related U.S. Application Data
(63) Continuation of application No. 11/975,602, filed on Oct. 22, 2007.

(51) Int. Cl. B05B 3/04; F16L 27/00

(52) U.S. Cl. 239/230; 239/264

(57) ABSTRACT

A rotatable sprinkler head apparatus has a sprinkler body and a sprinkler swivel for attaching the sprinkler head to a source of water. A spindle rotates in the swivel and has a flange at one end thereof. A three washer stack has upper and lower sealing washers with the upper sealing washer isolated from the rotating spindle by the wear washer and mounted in a counterbore area in the swivel to isolate the upper washer from the rotating spindle and reduce wear on the spindle. The washers counteract the force of the water leaving the sprinkler nozzle to reduce radial movement of the flanged end of the spindle and thus prevents grit from entering adjacent the washers.

This application is a continuation of my prior U.S. patent application Ser. No. 11/975,602, filed on Oct. 22, 2007, for SPRINKLER HEAD APPARATUS.

### BACKGROUND OF THE INVENTION

1. Field of the Invention

This invention relates to an irrigation sprinkler head and to a sprinkler head washer stack having a plurality of washers including a stationary swivel sealing washer isolated from the rotation of the sprinkler spindle by a wear washer.

2. Description of the Prior Art

Rotary head sprinklers, especially the impulse type step-by-step sprinklers, have been used extensively in irrigation of agricultural fields, groves, and the like. In dry seasons, these sprinklers may be used almost continuously to supply the moisture required for proper plant growth. Multiple sprinkler heads are frequently combined into large irrigation systems which are usually elevated above the crops to be irrigated. These irrigation systems may be fed with river, lake or well water.

In the past, attempts have been made to shield the lower bearing seal which separates the spindle and swivel mechanisms to permit the use of ordinary flat washers. A plurality of washers, called a washer stack, has been used to seal between the rotating spindle and the stationary swivel of a sprinkler head. This washer stack normally includes a flat wear washer sandwiched between two flat softer sealing washers. Water pressure applied to the sprinkler head and spindle flange forces the washers together and against the spindle. This causes the top generally stationary washer to scrub against the rotating spindle, eventually causing wear and shortening the life of the spindle and sprinkler head.

In U.S. Pat. Nos. 3,204,873 and 3,204,874, Senninger uses a single wear washer and a single seal which are both semi-shielded from the water flow. In U.S. Pat. No. 2,904,261 to Johnson, a single wear washer with two seals are used which are both semi-shielded from the water pressure. Costa, et al. U.S. Pat. No. 3,764,073 is for a sprinkler head mounting means and teaches a sprinkler head having sacrificial wear washers and special seals. It has a plastic slip washer having an angular cross section and an axial cylindrical wall. In Costa, U.S. Pat. No. 3,957,205, a sprinkler has a washer stack between the swivel and the spindle which includes a wear washer with sealing washers on both sides thereof. This patent also includes a metal ferule adjacent the wear washer to isolate the top seal from the rotating spindle. A metal ferule mounted over a rotating spindle is subject to wear and abrasion that can reduce the life of sprinkler parts.

In my prior U.S. Pat. No. 3,968,934, a sprinkler head bearing means is provided for a rotatable head sprinkler apparatus which incorporates a lower bearing seal having a wear washer and two seals having a generally T-shaped cross section mounted on either side of the wear washer. In my prior U.S. Pat. No. 4,062,494 I provide a sprinkler head sealing apparatus with seals and wear washers in which the wear washer has an angular groove formed in its outer periphery to thereby form a pair of angular ridges. A lower bearing seal has a tapered portion along with an annular lip protruding from its periphery. Epstein et al. U.S. Pat. No. 6,260,770 shows a sealing assembly for three sealing rings, two of which are made out of ceramic material and also has a second resilient ring.

The present invention is directed toward a three washer stack having upper and lower sealing washers and having the upper sealing washer isolated from the rotating spindle by the wear washer. The sealing bearings counteract the force of the water leaving the sprinkler nozzle to prevent radial movement of the flanged end of the spindle and thus prevents grit from entering adjacent the radial bearing.

### SUMMARY OF THE INVENTION

A rotatable sprinkler head apparatus has a sprinkler body and a sprinkler swivel having attaching means for attaching a rotatable sprinkler head apparatus to a source of water. The swivel has a bore therethrough. A spindle has a bore therethrough and is rotatably mounted through the sprinkler swivel bore and connected at one end to the sprinkler body and has a flange at the opposite end thereof. An improved washer stack has three washers thereon mounted around the spindle between the spindle flange and the end of the swivel. The washer stack includes a wear washer having an annular generally external ledge for forming a generally L-shape cross section rotatable with the spindle. An annular generally stationary sealing washer is mounted between a counterbored portion of the swivel and the wear washer external ledge and is isolated from contact with the rotating spindle while providing resistance to the radial movement of the spindle. This upper sealing washer does not touch the spindle so that spindle wear is reduced by the wear washer rotating relative to the generally stationary washer. The washer stack also includes a spindle washer positioned between the wear washer and the spindle flange which rotates with the spindle and the wear washer. The sealing washers are made of an elastomeric material.

### BRIEF DESCRIPTION OF THE DRAWINGS

Other objects, features, and advantages of the present invention will be apparent from the written description and the drawings in which:

FIG. 1 is a cut away sectional view of a sprinkler head having a washer stack in accordance with the present invention;

FIG. 2 is an exploded view of the washer stack and the spindle and swivel; and

FIG. 3 is a perspective view of a wear washer of the present invention.

### DETAILED DESCRIPTION OF THE PREFERRED EMBODIMENT

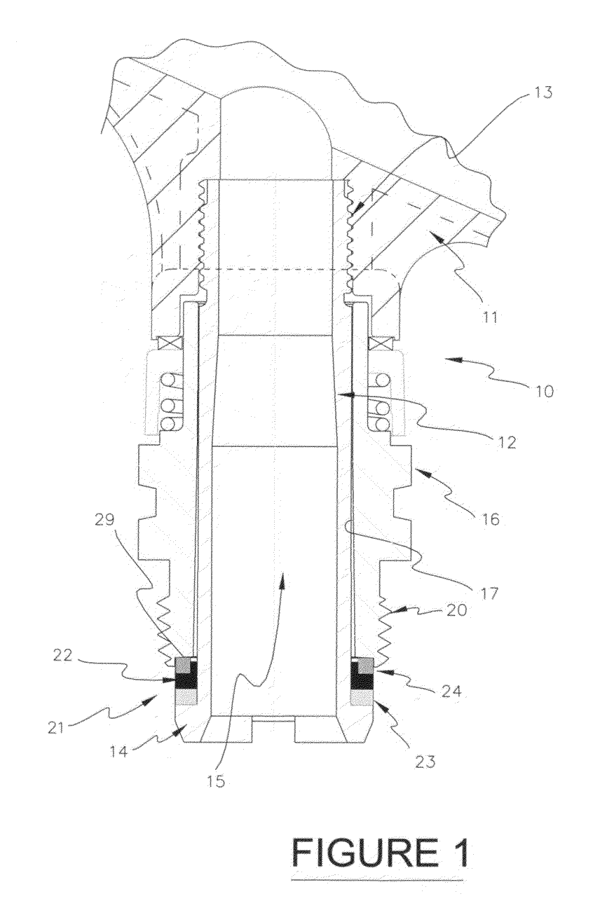

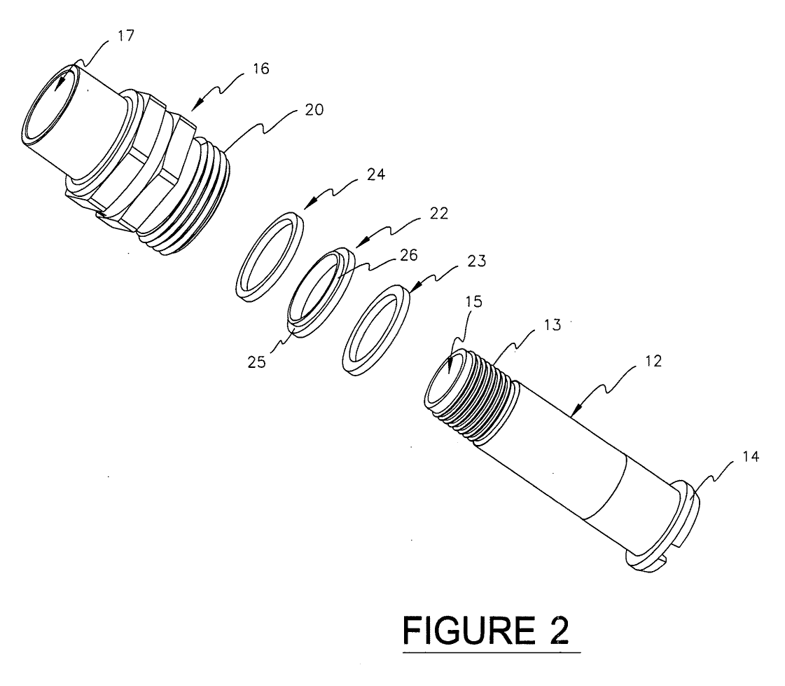

Referring to the drawings of FIGS. 1 through 3, a rotary irrigation sprinkler head 10 has a sprinkler head body 11 having a spindle 12 threadedly attached thereto with threads 13 at one end and having an annular spindle flange 14 at the other end. The spindle 12 has a passageway 15 extending therethrough for the passage of water from a water source. A swivel 16 has a passageway 17 passing therethrough and has a spindle 12 extending through the passageway 17 of the swivel 16. The swivel 16 has a counterbore 29 at one end and has external threads 20 for attaching to a water source, such as an irrigation pipe, at the other end. When the sprinkler head 10 is attached to a water source, water passes through the spindle bore 15 and into the sprinkler body 11 which distributes the water and causes the sprinkler body and spindle 12 to rotate.

An annular washer stack 21 includes three washers: a wear washer 22 and a lower rotating washer 23 adjacent the spindle flange 14 and rotatable with the spindle 12 and a sealing washer 24. The sealing washer 24 is mounted on the other side of the wear washer 22 in the countersunk area 29 of the swivel 16 and abutting the annular wall of the countersunk area 29 and abutting against the swivel 20 and against the wear washer 22 annular ledge 25. Thus the sealing washer 24 is isolated and has no contact the spindle 12. The washer 23 is held between the spindle flange 14 and wear washer 22. The stationary washer 24, as seen from FIG. 1, does not have contact with the spindle 12.

The wear washer 22 is seen to be an annular washer with a generally L-shaped cross section having a bottom ledge 25 and an annular side ledge or rim 26. The stationary washer 24 rides on the wear washer ledges 25 and 26, as seen in FIG. 1, and in the countersunk area 29 in the swivel 16. The washer 24 is stationary and mounted between the wear washer 22 rim 26 annular wall and swivel countersunk area 29 annual wall where the washer is isolated from the rotating spindle 12 while sealing and reinforcing the spindle.

In operation the spindle 12 rotates with the sprinkler body 11, the closely fitted wear washer 22 and the spindle washer 23. The sealing washer 24 is held stationary against the swivel and rotates on the wear washer 22 without any contact with the rotating spindle 12. The wear washer 22 is made of a relatively hard wear resistant material, such as TEFLON or an ultrahigh molecular weight polyethylene, while the washers 23 and 24 are made of a rubber or an elastomer, such as neoprene or Nitrile.

In the past, in a standard three-washer sprinkler bearing stack, water pressure forces the stationary top washer to scrub against the rotating spindle and eventually causes wear on the spindle, leakage and eventual destruction of the bearing. By the use of the present L-shaped wear washer 22 and an elastomeric washer 24 rotating against the wear washer 22, the spindle wear is eliminated thus prolonging the life of the sprinkler spindle and sprinkler head. Also the dual sealing washers provide pressure compensation against the flanged end of the spindle moving radially in the swivel which would otherwise move radially to open up the axial bearing for grit to enter. The washers also provide the long lasting friction brake necessary for proper operation of an impulse driven sprinkler.

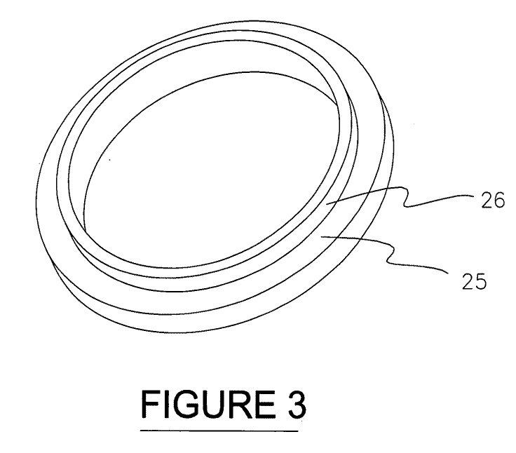

Referring more specifically to FIG. 3, the wear washer 22 is seen having annular ledges 25 and 26 for the stationary washer 24 to ride upon. The wear washer's wear connection is between the wear washer 22 and the stationary washer 24 while washer 24 has no contact with the rotating spindle 12, thereby prolonging the life of spindle 12.

It should be clear at this point that a rotating sprinkler head has been provided which advantageously reduces the wear on the rotating spindle by a wear washer rotating relative to a generally stationary sealing washer while counteracting the force of the water leaving the sprinkler nozzle to prevent radial movement of the flanged end of the spindle to prevent grit from entering between the axial bearing surfaces. The present invention however is not to be construed as limited to the particular forms shown which are to be considered illustrative rather than restrictive.

I claim:

1. A rotatable sprinkler head apparatus having:
a sprinkler body;
a sprinkler swivel having attaching means for attaching to a source of water on one end, said swivel having a bore therethrough and a counterbore on the attaching end thereof;
a spindle having a bore therethrough rotatably mounted through said sprinkler swivel bore and connected at one end to said sprinkler body and having a flange at the opposite end thereof;
a washer stack having three washers thereon mounted around said spindle between said spindle flange and said swivel counterbore end, said washer stack including a wear washer having an annular generally external ledge forming a generally L-shaped cross-section rotatable with said spindle and an annular stationary washer mounted between said swivel counterbore portion thereof and said wear washer external ledge and thereby being isolated from said rotating spindle, and a spindle washer positioned between said wear washer and said spindle flange and rotatable on said spindle;
whereby spindle wear and radial movement are reduced by said generally stationary sealing washer being mounted between the wear washer annular ledge and in the swivel counterbore portion and isolated from said rotating spindle.

2. The rotatable sprinkler head apparatus in accordance with claim 1 in which said spindle washer rotates with said spindle.

3. The rotatable sprinkler head apparatus in accordance with claim 2 in which said stationary washer is an elastomeric washer.

4. The rotatable sprinkler head apparatus in accordance with claim 3 in which said stationary washer is made of Nitrile.

5. The rotatable sprinkler head apparatus in accordance with claim 4 in which said spindle washer is an elastomeric washer.

6. The rotatable sprinkler head apparatus in accordance with claim 3 in which said spindle washer is made of Nitrile.

7. The rotatable sprinkler head apparatus in accordance with claim 5 in which said spindle wear washer is a polyethylene washer.

8. A rotatable sprinkler head apparatus in accordance with claim 5 in which said spindle wear washer is made of ultra high molecular weight polyethylene.
